(19) United States
(12) Patent Application Publication
(10) Pub. No.: US 2017/0146183 A1
(43) Pub. Date: May 25, 2017

(54) LINEAR-ELEVATION HOLDING APPARATUS

(71) Applicant: Chung-Ting LAN, Taipei City (TW)

(72) Inventor: Chung-Ting LAN, Taipei City (TW)

(21) Appl. No.: 14/947,049

(22) Filed: Nov. 20, 2015

(51) Int. Cl. F16M 11/38; F16M 11/18

(52) U.S. Cl. CPC F16M 11/38; F16M 11/18

(57) ABSTRACT

A linear-elevation holding apparatus includes a loading board, an upper connection structure, a lower connection structure, an elevating structure, and an adjustment structure. The upper connection structure is disposed on the loading board. The upper and the lower connection structures are spaced apart and placed corresponding to each other. The elevating structure includes a first and a second connection portions movably connected between the upper and the lower connection structures. The elevating structure ascends/descends through the relative movement between the first connection portion and the second connection portion. The adjustment structure includes a screw rod pivotally connected to the first connection portion and a connecting element, and the screw rod is threadedly connected to the connecting element to control the relative movement between the first and the second connection portions to achieve linear ascending/descending of the loading board.

### TECHNICAL FILED

The present invention relates to a holding apparatus and, in particular, to a linear-elevation holding apparatus.

### BACKGROUND OF THE INVENTION

There are holding devices which can hold and support various electronic products such as televisions, laptops, tablet computers, or computer screens. For storing, a conventional holding device is ascendable/descendible so as to be collapsed and stored after descent, and to be expanded to hold the products after ascent. The conventional holding device includes a loading board and an elevating structure disposed on the loading board.

However, the elevating structure of the conventional holding device has a defect in its design. The defect is that, in the ascending/descending process, the loading board moves obliquely upward or obliquely downward, so ascent/decent requires a larger space. Moreover, after the products are loaded, the load force direction (stress direction) does not correspond to the ascending/descending direction (i.e., there is an included angle between the load force direction and the ascending/descending direction), so the whole structure is not stable and tends to topple.

Accordingly, the inventor made various studies to improve the above-mentioned defect, on the basis of which the present invention is accomplished.

### SUMMARY OF THE INVENTION

It is an object of the present invention to provide a linear-elevation holding apparatus which can ascend straight upward to be expanded or descend straight downward to be collapsed, and whereby a loading board ascends/descends linearly, ascent/descent requires a small space, and the whole structure is stable and prevented from toppling.

Accordingly, the present invention provides a linear-elevation holding apparatus, comprising: a loading board; an upper connection structure disposed on one side of the loading board; a lower connection structure disposed corresponding to the upper connection structure and spaced apart from the same; an elevating structure including a first connection portion and a second connection portion which are both movably connected between the upper connection structure and the lower connection structure, the elevating structure ascending or descending through relative movement between the first connection portion and the second connection portion; and an adjustment structure including a connecting element disposed on the second connection portion and a screw rod rotatable by an external force, one end of the screw rod being pivotally connected to and positioned to the first connection portion, a portion of the screw rod being threadedly connected to the connecting element to control the relative movement between the first connection portion and the second connection portion to achieve linear ascending/descending of the loading board.

Compared to conventional techniques, the present invention has the following effects. By the collaboration between the screw rod and movable elevating structure, the linear-elevation holding apparatus can ascend straight upward or descend straight downward to be expanded or collapsed, so the loading board can ascend or descend linearly, ascent/descent requires a small space, and a load force direction corresponds to an ascending/descending direction, and thus the whole structure is stable and prevented from toppling.

### BRIEF DESCRIPTION OF THE DRAWINGS

The disclosure will become more fully understood from the detailed description and the drawings given herein below for illustration only, and thus does not limit the disclosure, wherein:

FIG. 1 is a top perspective view of a linear-elevation holding apparatus in an expanded configuration according to the present invention;

FIG. 2 is a bottom perspective view of the linear-elevation holding apparatus in the expanded configuration according to the present invention;

FIG. 3 is a perspective exploded view of the linear-elevation holding apparatus (without a loading board) according to the present invention;

FIG. 4 is a cross-sectional view taken along line 4-4 of FIG. 1, showing the linear-elevation holding apparatus of the present invention;

FIG. 5 is a cross-sectional view taken along line 5-5 of FIG. 1, showing the linear-elevation holding apparatus of the present invention;

FIG. 6 is a bottom perspective view of the linear-elevation holding apparatus in a collapsing process according to the present invention;

FIG. 7 is a cross-sectional view of FIG. 6 showing the linear-elevation holding apparatus of the present invention;

FIG. 8 is a bottom perspective view of the linear-elevation holding apparatus in a collapsed configuration according to the present invention;

FIG. 9 is a cross-sectional view of FIG. 8 showing the linear-elevation holding apparatus according to the present invention; and

FIG. 10 is a bottom perspective view of the linear-elevation holding apparatus according to another embodiment of the present invention.

### DETAILED DESCRIPTION

Detailed descriptions and technical contents of the present invention are illustrated below in conjunction with the accompany drawings. However, it is to be understood that the descriptions and the accompany drawings disclosed herein are merely illustrative and exemplary and not intended to limit the scope of the present invention.

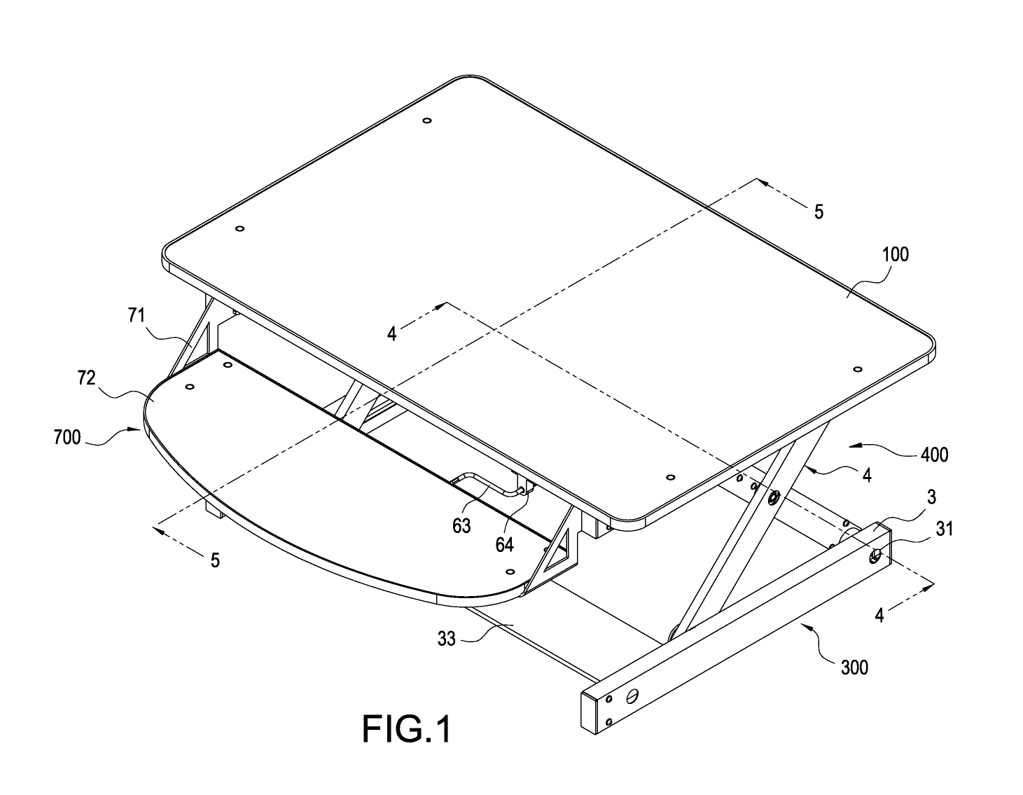

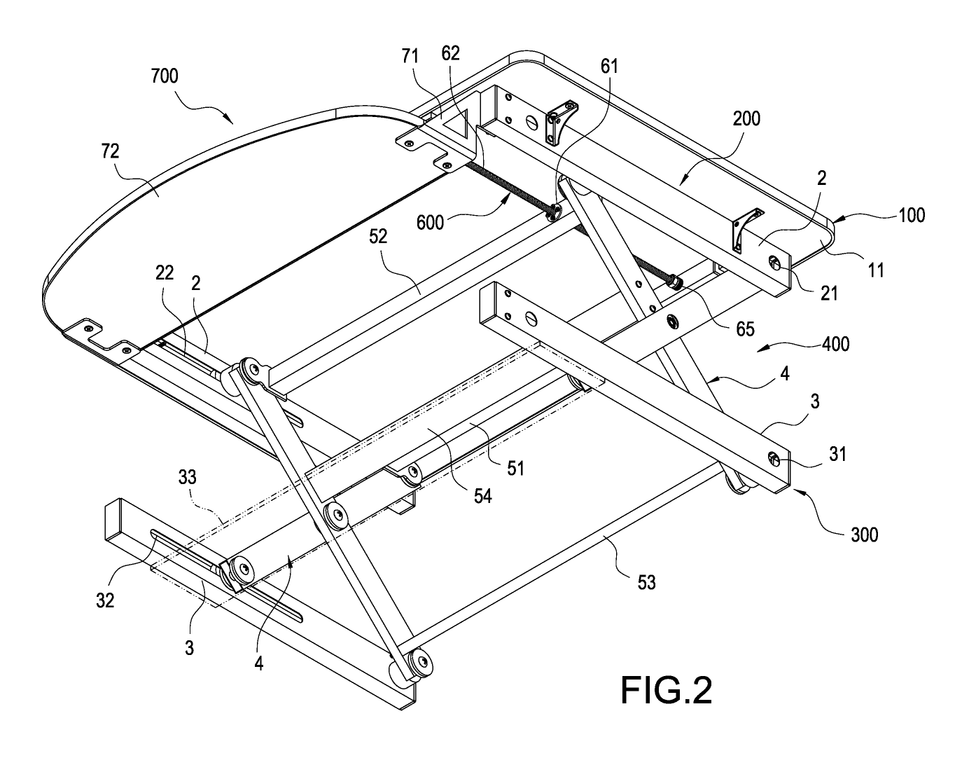

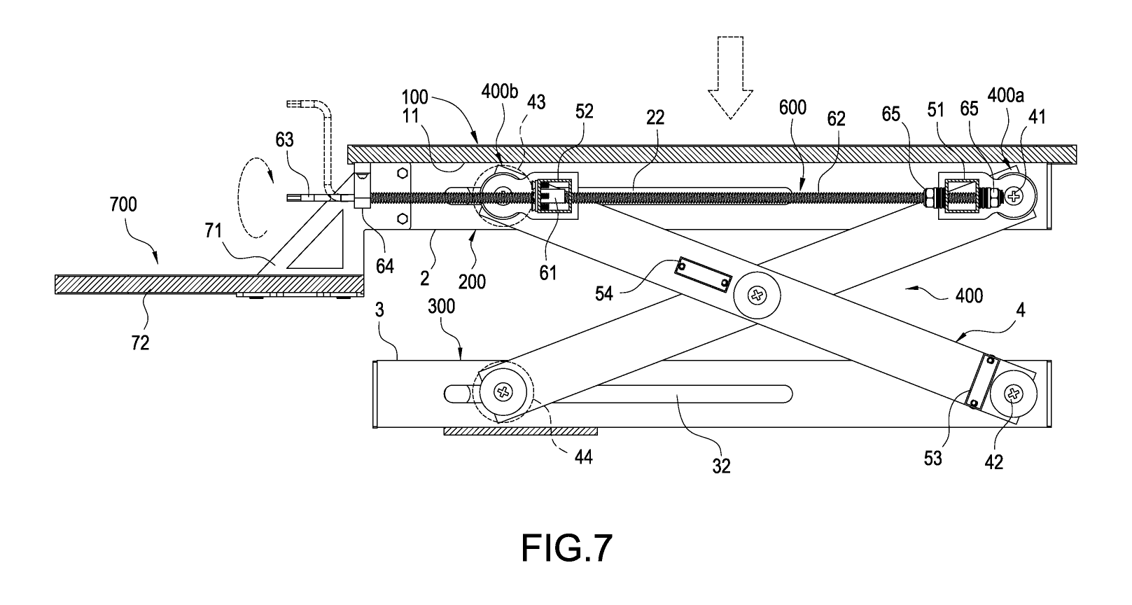

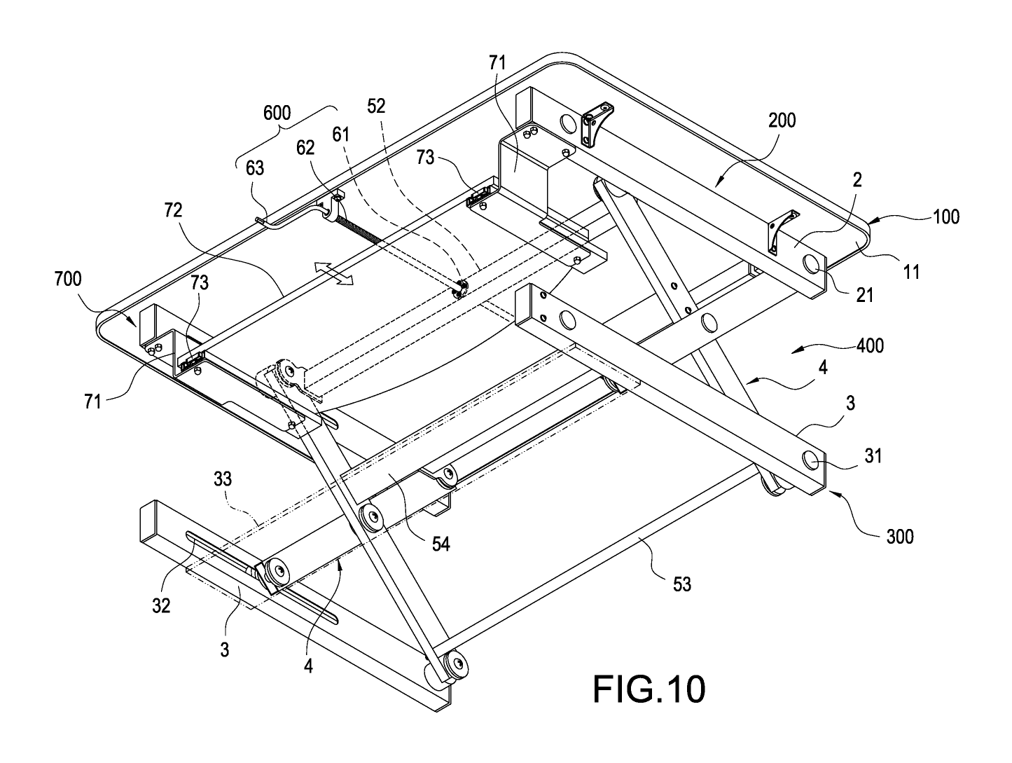

The present invention provides a linear-elevation holding apparatus. FIGS. 1 to 9 show one embodiment of the present invention. FIG. 10 shows another embodiment of the present invention. The linear-elevation holding apparatus is configured to hold and support any object. In the present embodiment and the other embodiment, the holding apparatus holds and supports a computer as an example.

Referring to FIGS. 1, 2, 3, and 4, one embodiment of the present invention provides a linear-elevation holding apparatus which comprises a loading board 100, an upper connection structure 200, a lower connection structure 300, an elevating structure 400, and an adjustment structure 600. The loading board 100 includes a surface side (not labelled) and a bottom side 11 opposite to the surface side.

The upper connection structure 200 is disposed on the bottom side 11 of the loading board 100. The lower connection structure 300 is disposed below the upper connection structure 200, and the upper connection structure 200 is disposed corresponding to and spaced apart from the lower connection structure 300.

The upper connection structure 200 includes two upper support rods 2, each of the two upper support rods 2 includes a pivot hole 21 and a slide groove 22, the pivot holes 21 of the two upper support rods 2 are disposed corresponding to each other, and the slide grooves 22 of the two upper support rods 2 are also disposed corresponding to each other. The lower connection structure 300 includes two lower support rods 3, each of the two lower support rods 3 includes a pivot hole 31 and a slide groove 32, the pivot holes 31 of the two lower support rods 3 are disposed corresponding to each other, and the slide grooves 32 of the two lower support rods 3 are also disposed corresponding to each other. The slide grooves 22 and the slide grooves 32 respectively extend longitudinally along the respective upper support rod 2 and the respective lower support rod 3. Furthermore, a connecting board 33 can be further connected between the two lower support rods 3.

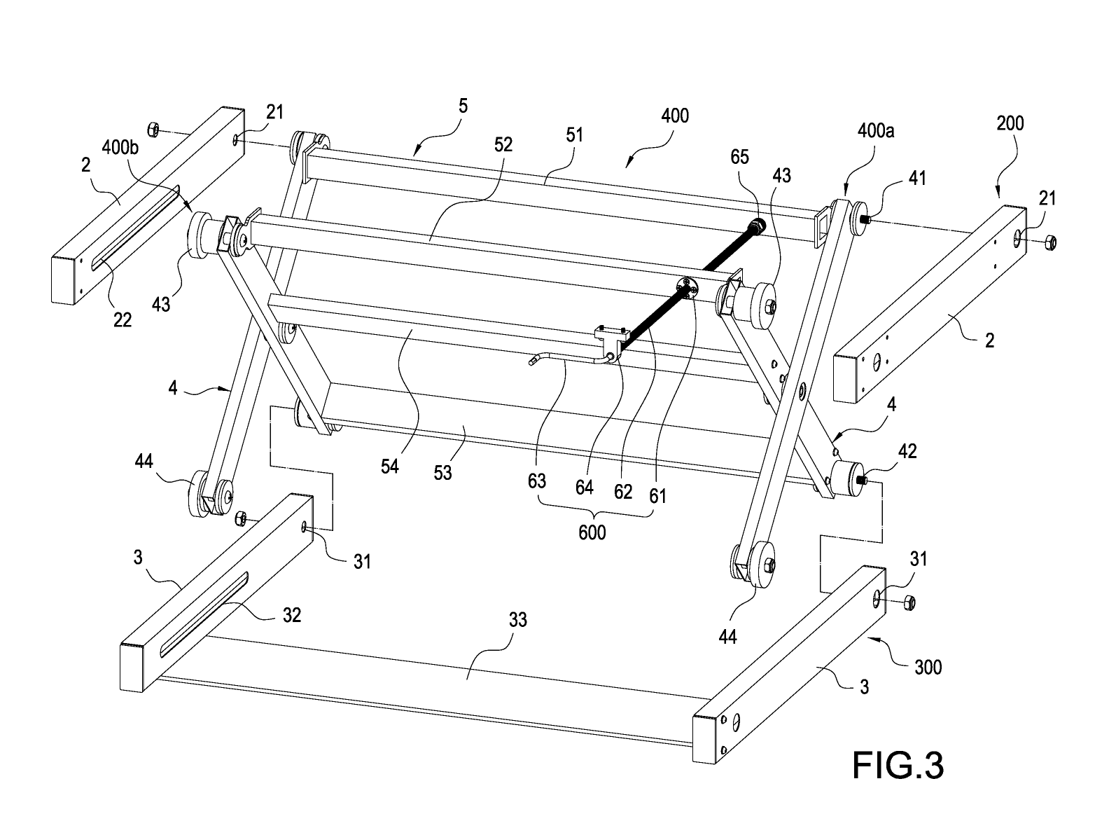

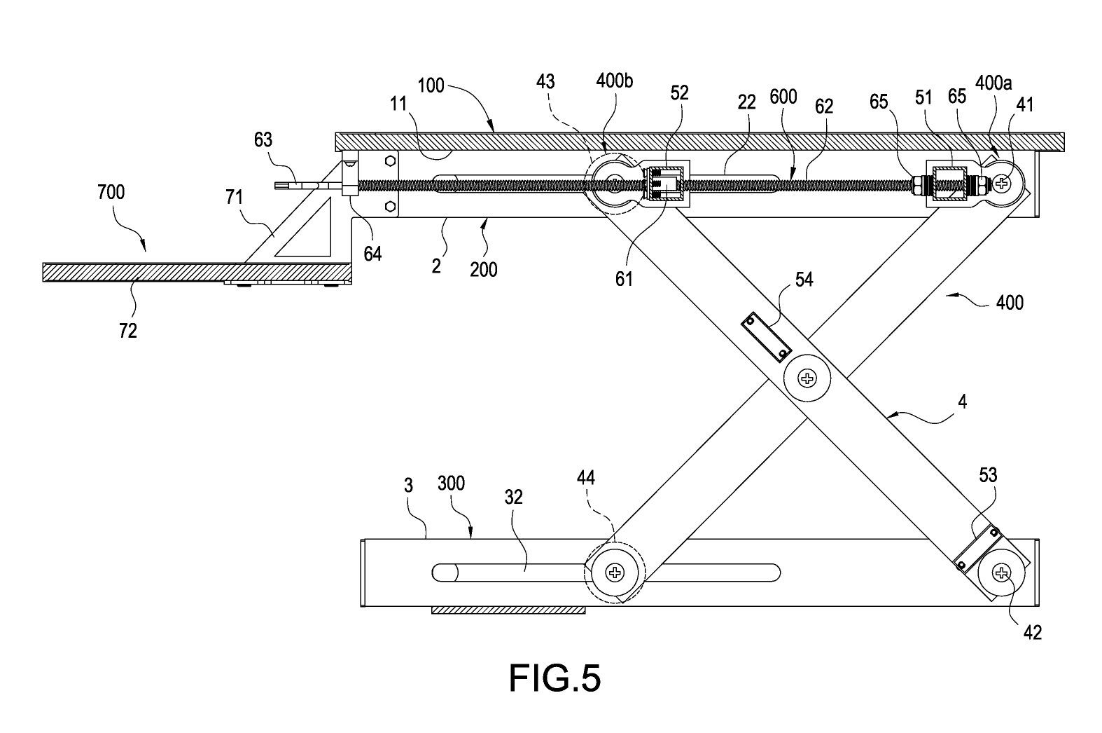

The elevating structure 400 includes two cross pivot elements 4 and a linkage set 5 connected between the two cross pivot elements 4. As shown in FIG. 3, each cross pivot element 4 includes two intersecting support elements (not labelled), the two support elements are pivotally connected at their intersection, so that the two support elements can pivot about the intersection to be opened or closed. Four ends of each of the cross pivot elements 4 are two pivot ends 41, 42 and two slide connection ends 43, 44. Each of the pivot ends 41, 42 can be a pivot, and each of the slide connection ends 43, 44 can be a glide wheel; however, the present invention is not limited in this regard. All of the pivot ends 41, 42 of the two cross pivot elements 4 form a first connection portion 400a (the first connection portion 400a is a face created by connecting four points, i.e. the four pivot ends 41, 42, as shown in FIGS. 3 and 5). All of the slide connection ends 43, 44 of the two cross pivot elements 4 form a second connection portion 400b (the second connection portion 400b is a face created by connecting four points, i.e. the four slide connection ends 43, 44, as shown in FIGS. 3 and 5). The first connection portion 400a and the second connection portion 400b are movably connected between the upper connection structure 200 and the lower connection structure 300. The elevating structure 400 ascends or descends through the relative movement between the first connection portion 400a and the second connection portion 400b.

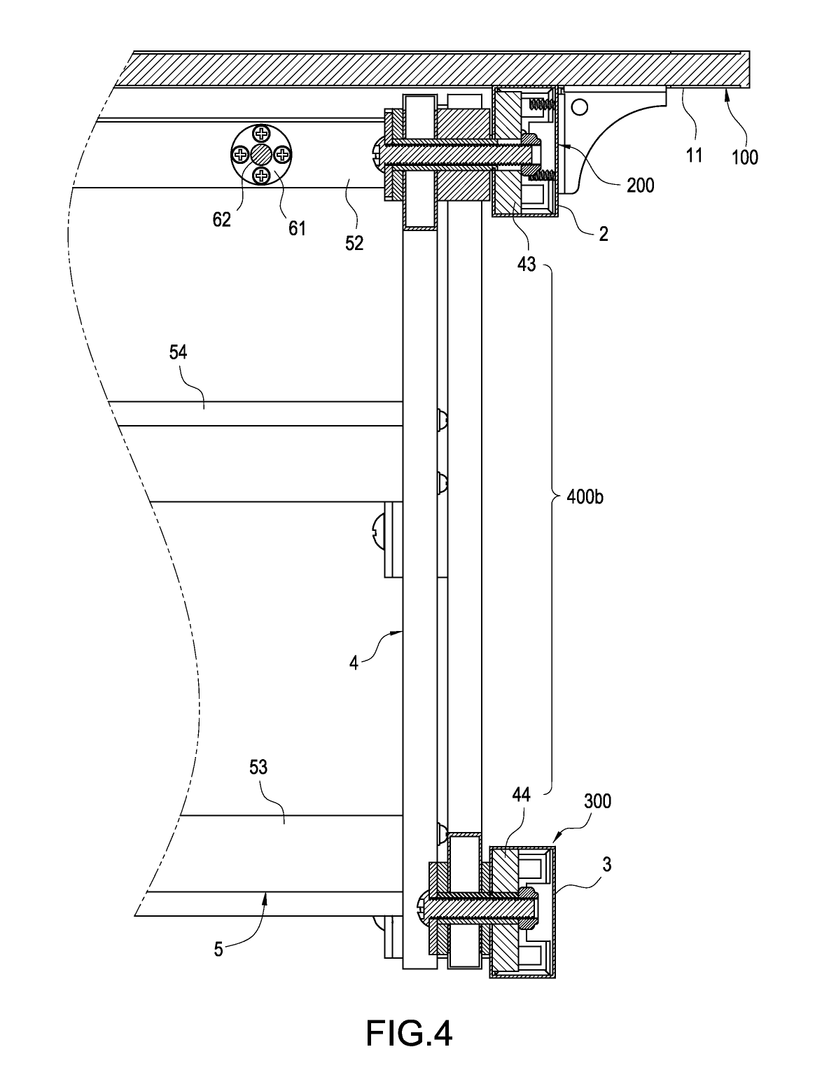

The two pivot ends 41 and 42 of each cross pivot element 4 are respectively pivotally connected to the pivot hole 21 of the upper support rod 2 and the pivot hole 31 of the lower support rod 3. The two slide connection ends 43, 44 of each cross pivot element 4 are respectively pivotally connected to the slide groove 22 of the upper support rod 2 and the slide groove 32 of the lower support rod 3. The slide connection ends 43, 44 are rotatable and slidable in the slide grooves 22, 23 of the upper support rod 2 and the lower support rod 3 by means of the glide wheels (see FIG. 4). Therefore, the elevating structure 400 can ascend or descend linearly by the second connection portion 400b slidable with respect to the first connection portion 400a, thereby achieving linear ascending/descending of the loading board 100.

The linkage set 5 includes a first linkage rod 51 connected between the upper pivot ends 41 of the two cross pivot elements 4, a second linkage rod 52 connected between the upper slide connection ends 43 of the two cross pivot elements 4, a third linkage rod 51 connected between the lower pivot ends 42 of the two cross pivot elements 4, and preferably further includes a fourth linkage rod 54 connected between the two cross pivot elements 4 in close proximity to their intersection. The first linkage rod 51 and the second linkage rod 52 are disposed corresponding to and spaced apart from each other.

The adjustment structure 600 includes a connecting element 61 disposed on the second connection portion 400b and a screw rod 62 rotatable by an external force. In the present embodiment, the connecting element 61 is disposed on the second linkage rod 52 as an example. One of two ends of the screw rod 62 is pivotally connected to and positioned to the first connection portion 400a. In the present embodiment, this one end of the screw rod 62 is pivotally connected to and positioned to the first linkage rod 51 as an example. The main body of the screw rod 62 between its two ends is threadedly connected to the connecting element 61, so that the screw rod 62 can control the second linkage rod 52 to get father from or closer to the first linkage rod 51.

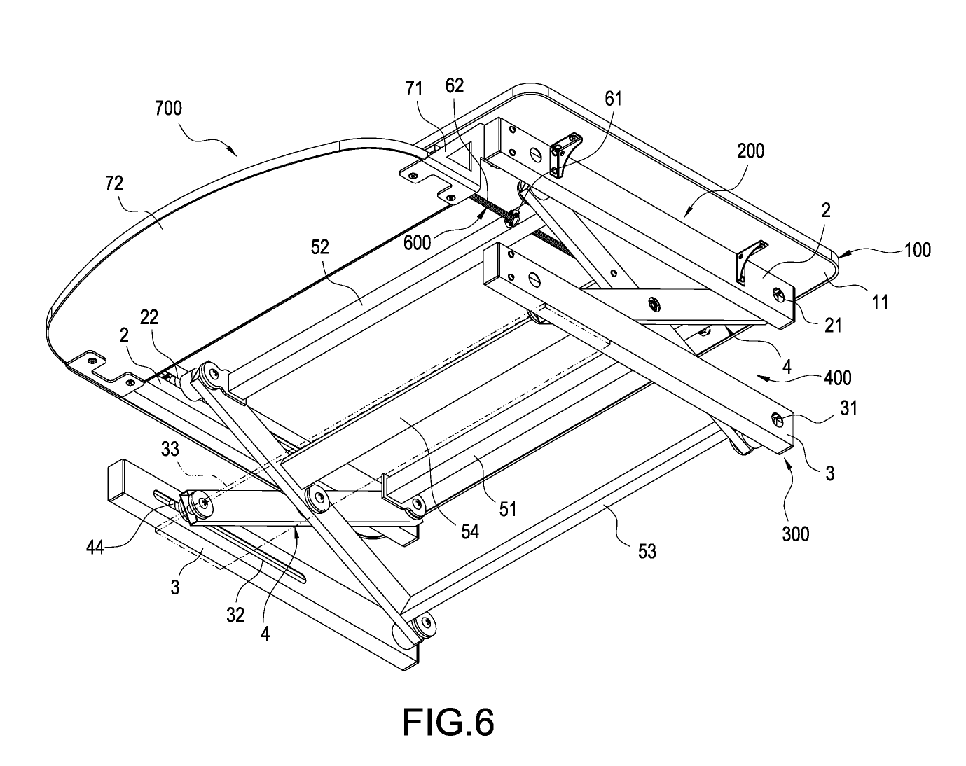

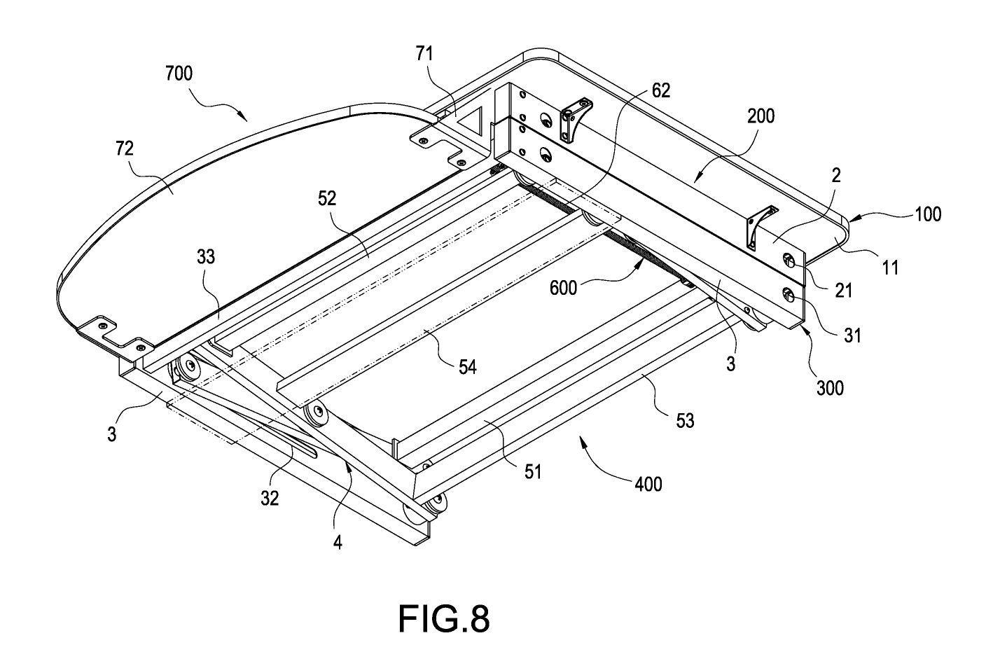

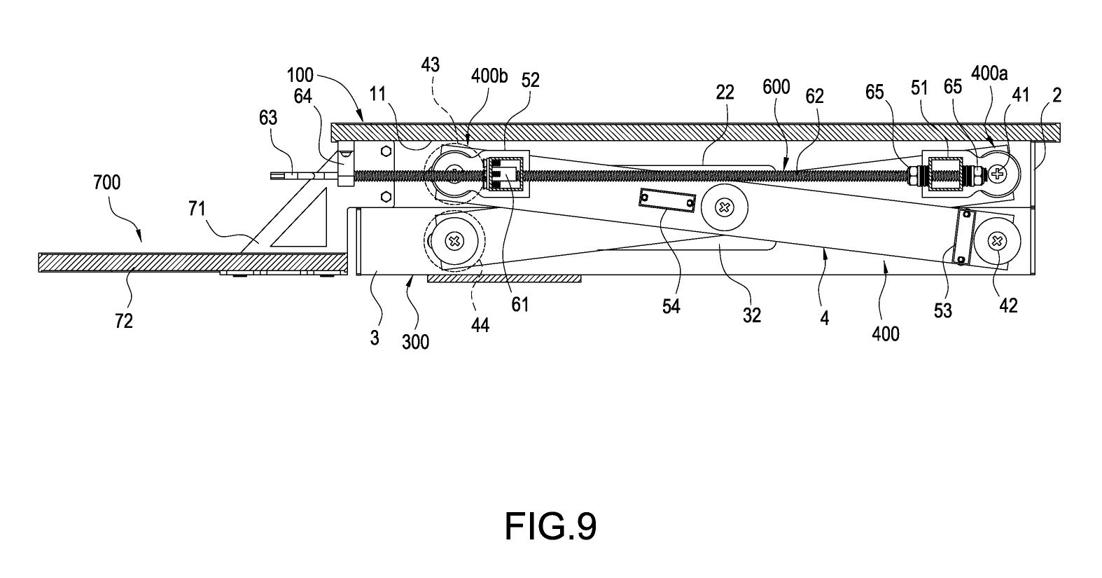

Thus, as shown in FIGS. 6, 7, 8 and 9, when an external force is exerted to the screw rod 62 by a driver (e.g. a motor) or a person's hands to make the screw rod 62 rotate, the second linkage rod 52 threadedly connected to the screw rod 62 moves away from or comes closer to the first linkage rod 51. When the second linkage rod 52 moves away from the first linkage rod 51, the cross pivot elements 4 are opened wide to reduce the height from the top to the bottom, so the elevating structure 400 can be collapsed upon descent, and the upper connection structure 200 and the lower connection structure 300 are brought into contact with each other to become a fully collapsed configuration (see FIGS. 8 and 9). As shown in FIGS. 1, 2 and 5, when the second linkage rod 52 comes closer to the first linkage rod 51, the cross pivot elements 4 are folded up to increase the height from the top to the bottom, so the elevating structure 400 can be expanded upon ascent.

The adjustment structure 600 preferably further includes a rotation element 63, a support 64 and at least two fixing elements 65. The support 64 is disposed on the bottom side 11 of the loading board 100, the rotation element 63 is pivotally connected to the support 64 and is connected to the other end of the two ends of the screw rod 62. In that way, the rotation element 63 can be rotated by a person's hand, and the rotation element 63 can drive the screw rod 62 to rotate.

In order to fix one of the two ends of the screw rod 62 to the first linkage rod 51, as shown in FIG. 5, after the screw rod 62 is pivotally connected to the first linkage rod 51, two fixing elements are respectively threadedly connected to two sides where the screw rod 62 is pivotally connected. By doing so, one of the two ends of the screw rod 62 can be pivotally connected to the first linkage rod 51, and the first linkage rod 51 is also positioned between the two fixing elements 65. Certainly, after the height is adjusted by a user as required, the screw rod 62 is not rotatable since the two fixing elements 65 abut against the first linkage rod 51 at two sides thereof, and such that the height can be fixed and limited as just adjusted.

Furthermore, in one embodiment of the present invention, the linear-elevation holding apparatus can further include a keyboard support structure 700. The keyboard support structure 700 includes a keyboard support plate 72 and a plurality of frames 71 connected between the upper support rod 2 and the keyboard support plate 72. The frames 71 support the keyboard support plate 72, so that a keyboard (not illustrated) can be placed on the keyboard support plate 72.

Referring to FIG. 10 showing another embodiment of the present invention, this embodiment is similar to the above-mentioned embodiment with the difference that the keyboard support structure 700 further includes a plurality of slide rails 73. Each of the slide rails 73 is disposed between the keyboard support plate 72 and each of the frames 71, so that the keyboard support plate 72 can slide inwardly or outwardly by means of each of the slide rails 73. When the keyboard support plate 72 slides outwardly, the keyboard can be laid thereon. When the keyboard support plate 72 slides inwardly, it makes the linear-elevation holding apparatus transformed into a more complete collapsed configuration.

In summary, compared to conventional techniques, the present invention has the following effects. By the collaboration between the screw rod 62 and the movable elevating structure 400, the linear-elevation holding apparatus can ascend straight upward or descend straight downward to be expanded or collapsed, so the loading board 100 is driven to ascend or descend linearly, ascent/descent requires a small space, and a load force direction corresponds to an ascending/descending direction, thus the whole structure is stable and prevented from toppling. Furthermore, the linear-elevation holding apparatus can be transformed into a fully collapsed configuration to greatly reduce a volume by collapsing to facilitate receiving and storing.

In addition, the present invention has other function. By adding the slide rails 73 to the keyboard support structure 700, when the linear-elevation holding apparatus is collapsed, the keyboard support plate 72 can slide inwardly to be received and hidden in the elevating structure 400.

It is to be understood that the above descriptions are merely the preferable embodiments of the present invention and are not intended to limit the scope of the present invention. Equivalent changes and modifications made in the spirit of the present invention are regarded as falling within the scope of the present invention.

1. A linear-elevation holding apparatus, comprising:
a loading board;
an upper connection structure disposed on one side of the loading board;
a lower connection structure disposed corresponding to the upper connection structure and spaced apart from the same;
an elevating structure including a first connection portion and a second connection portion which are both movably connected between the upper connection structure and the lower connection structure, the elevating structure ascending or descending through relative movement between the first connection portion and the second connection portion;
an adjustment structure including a connecting element disposed on the second connection portion and a screw rod rotatable by an external force, one end of the screw rod being pivotally connected to the first connection portion, a portion of the screw rod being threadedly connected to the connecting element to control the relative movement between the first connection portion and the second connection portion to achieve linear ascending or descending of the loading board, and
a keyboard support structure including a keyboard support plate;
wherein the elevating structure includes two cross pivot elements and a plurality of linkage rods connected between the two cross pivot elements, four ends of each of the cross pivot elements are two pivot ends and two slide connection ends, all of the pivot ends of the two cross pivot elements form the first connection portion and all of the slide connection ends of the two cross pivot elements form the second connection portion, the two pivot ends of each of the two cross pivot elements are pivotally connected to the upper connection structure and the lower connection structure respectively, and the two slide connection ends of each of the two cross pivot elements are slidably connected to the upper connection structure and the lower connection structure respectively,
wherein the upper connection structure includes two upper support rods, the lower connection structure includes two lower support rods, each of the two upper support rods and each of the two lower support rods include a pivot hole and a slide groove, the two pivot ends of each of the cross pivot elements are pivotally connected to the respective pivot holes of the upper connection structure and the lower connection structure, and the two slide connection ends of each of the cross pivot elements are accommodated inside the two upper support rods and the two lower support rods and slidably connected to the respective slide grooves of the upper connection structure and the lower connection structure;
wherein the keyboard support plate is connected to and moved along with the upper support rod; and
wherein the upper support rod and the lower support rod are capable of contacting to each other when the elevating structure is in a folded mode.

2. (canceled)

3. The linear-elevation holding apparatus of claim 1, wherein a first linkage rod is connected between one of the pivot ends of each of the cross pivot elements, a second linkage rod is connected between one of the slide connection ends of each of the cross pivot elements, the first linkage rod and the second linkage rod are disposed corresponding to and separated from each other, the connecting element is disposed on the second linkage rod, and the one end of the screw rod is pivotally connected to the first linkage rod via the connecting element.

4. (canceled)

5. The linear-elevation holding apparatus of claim 1, wherein each of the slide grooves of the upper connection structure extends longitudinally along each of the upper support rods, and each of the slide grooves of the lower connection structure extends longitudinally along each of the lower support rods.

6. The linear-elevation holding apparatus of claim 1, wherein the adjustment structure further includes a rotation element, and the rotation element is connected to the other end of the screw rod.

7. The linear-elevation holding apparatus of claim 6, wherein the adjustment structure further includes a support disposed on the one side of the loading board, and the rotation element is pivotally connected to the support to drive the screw rod to rotate.

8. The linear-elevation holding apparatus of claim 1, wherein the keyboard support structure further includes a plurality of frames connected between the upper connection structure and the keyboard support plate.

9. The linear-elevation holding apparatus of claim 8, wherein the keyboard support structure further includes a plurality of slide rails, and each of the slide rails is disposed between the keyboard support plate and each of the frames.

10. The linear-elevation holding apparatus of claim 1, wherein the second connection portion is slidably connected between the upper connection structure and the lower connection structure, and by means of the second connection portion, the elevating structure is slidable with respect to the first connection portion to ascend or descend.
